(19) United States
(12) Patent Application Publication
(10) Pub. No.: US 2009/0246342 A1
(43) Pub. Date: Oct. 1, 2009

(54) METHOD FOR PROCESSING FLUID DAIRY, FRUIT OR VEGETABLE JUICES AND BEVERAGE CONCENTRATES FORMULATED FOR BEVERAGE PRODUCTS INTENDED FOR HUMAN CONSUMPTION TO PROTECT AGAINST DELIBERATE CONTAMINATION WITH PATHOGENIC AGROTERRORISM AGENTS

(76) Inventors: George H. Clark, Woburn, MA (US); Mary Ann Clark, Woburn, MA (US)

Correspondence Address: LORUSSO & ASSOCIATES, PO BOX 21915, PORTSMOUTH, NH, 03801, US

(21) Appl. No.: 12/309,513

(22) PCT Filed: Jul. 17, 2007
(86) PCT No.: PCT/US2007/016215

§ 371 Date: Jan. 21, 2009

Related U.S. Application Data
(60) Provisional application No. 60/831,418, filed on Jul. 17, 2006.

(51) Int. Cl. A23L 2/74; A23L 3/3445

(52) U.S. Cl. 426/491; 426/495

(57) ABSTRACT

A method for purifying fluids without compromising the components of the fluid is disclosed. Fluid dairy, fruit, vegetable and/or beverage concentrates are processed using pasteurization and filtration steps selectively applied to separate phase-separated components of the fluid to eliminate contaminants including agro- and biological terrorism contaminants such as bacteria and viruses.

### CROSS-REFERENCE TO RELATED APPLICATIONS

A claim of benefit is made to U.S. Provisional Application No. 60/831,418, filed Jul. 17, 2006, the contents of which are incorporated in their entirety herein by reference.

### FIELD OF THE INVENTION

This disclosure relates to a method of processing fluid dairy, fruit or vegetable juices to eliminate contaminants such as pathogenic agro-terrorism agents. More specifically, the disclosure relates to a method of processing fluids using phase separation to isolate solids from fluids to protect temperature and/or pressure sensitive components of a fluid while eliminating contaminants.

### BACKGROUND OF THE INVENTION

It is well known that dairy, fruit and/or vegetable fluids and/or juices must be processed to ensure compliance with federal regulations regarding product purity. Milk, juice and beverages are susceptible to deliberate contamination with potentially harmful agroterrorism agents such as bacteria, bacterial toxins e.g., Botulinum toxins, staphylococcal enterotoxins, Saxitoxin, Dinoflagellate toxins, viruses, and/or other chemical agents. Classical heat treatment such as HTST Pasteurization (High Temperature, Short Time) or UHT Pasteurization (Ultra High Temperature) will not kill all of the above bacteria or viruses and further will not inactivate 100% of the toxins.

Deliberate contamination of dairy, fruit or vegetable juices and other beverages with biological agents has already been attempted in the USA. The US dairy, fruit and vegetable juice and beverage industries are increasingly characterized by centralized production and wide distribution of products. Deliberate contamination of dairy, fruit or vegetable juice or other beverage products could cause an outbreak of disease with many illnesses dispersed over wide geographical areas.

Dependent on the biological agent used and the beverage (dairy, fruit or vegetable juice or other beverage) chosen as the carrier, an outbreak of disease with many illnesses dispersed over wide geographical areas could be initiated. Such an outbreak could either present as a slow, diffuse and initially unremarkable increase in sporadic cases or as an explosive epidemic suddenly producing a multitude of illnesses.

In an effort to improve current pasteurization methods to provide a safe supply of fluid milk, fruit or vegetable juices or beverage concentrates to make beverages for human consumption, a Component Specific Pasteurization (CSP™) Process is described using raw milk as an example of the starting fluid to be processed below:

What is needed and what we have invented is a method for isolating temperature and/or pressure sensitive ingredients of fluids prior to pasteurization and further processing for recombination into a pure bacteria-free, viral-free and toxin-free fluid.

### SUMMARY OF THE INVENTION

The method disclosed herein involves the phase separation of fluids into solid and liquid phases. The separated phases are selectively exposed to a series of pasteurization and filtration steps to remove contaminants including pathogenic bacteria, bacterial spores, viruses and biological toxins without compromising or diminishing the contents of the fluid.

The fluids can include dairy, fruit, vegetable and/or beverage concentrates. In one aspect of the invention, the fluids are collected and pooled in a refrigerated holding tank. The collected fluid is treated with a combination of carbon dioxide and nitrogen gas to eliminate bacteria.

In another aspect of the invention, the fluid is passed through microfilters to remove bacteria and spores. The fluid is then passed through nanofilters to separate the solid and liquid phases of the fluid. The liquid phase is passed through a reverse osmosis filter system to further eliminate organic and inorganic contaminants.

The solid phase is absorbed with cellulose, beads coated with pectin and immunoglobulins to bind and remove pathogens. The combined solids and beads are passed through microfilters to remove the coated beads from the fluid solids. The toxin and viral-free solids are recombined with the liquid phase to reconstitute the fluid for safe human consumption. These and other advantages will become apparent from a reading of the following detailed description.

### DETAILED DESCRIPTION OF THE INVENTION

The fluid purification method in its broadest aspect comprises raw milk, juice or beverage concentrate from either an organic or non-organic source. The selected fluid is pooled in a refrigerated receiving (holding) tank. While in the tank, the fluid is treated with a combination of carbon dioxide and nitrogen gas for from about 2 minutes to about 15 minutes. In one embodiment, the liquid is treated for about 10 minutes with the gas combination. The carbon dioxide/nitrogen gas combination is present in an amount from about 0.5 volumes to about 6 volumes of carbon dioxide and/or nitrogen gas (95% CO₂+5% N₂).

In one aspect of the invention, raw milk is the fluid being purified. After treatment with the gas combination, the milk is passed through a cream separator until substantially all or all of the cream has been separated from the milk, which is now in the form of skim milk.

After separation, the cream is separately pasteurized by UHT. After pasteurization, the cream may be used processed into other products such as ice cream or pharmaceutical components, if desired. The cream may also be pooled for bulk sale or recombination into various milk formulations.

The skim milk is also separately pasteurized by UHT. The skim milk is next passed through microfiltration, filters with pores ranging from about X microns to about Y microns. The microfiltration step removes bacteria and spores from the fluid. The step is performed under ambient temperature and pressure conditions.

To separate the solid and liquid phases of the skim milk fluid, the fluid is passed through nanofiltration. The nanofilters have pores ranging from about 0.1 to about 100 nanometers. The nanofiltration step is performed under ambient temperature and pressure conditions.

The water phase is passed through a reverse osmosis filter system as is well known in the art to remove any further organic or inorganic contaminants. The purified water phase may be retained for recombination, if desired.

The solid phase (milk solids) derived from the nanofiltration step is absorbed with beads of cellulose and pectin coated with bovine Anti-IgG and Anti-IgA. The bead components bind with the solids to further remove any contaminants.

To separate the beads from the beads/solid phase mixture, the mixture is passed through microfiltration, which removes the coated beads. Pore sizes from about 0.01 microns to about 50 microns. The step is performed under ambient temperature and pressure conditions.

The separated beads can be collected and regenerated for reuse. The purified solid phase material (milk solids) is recombined with the stored water phase to reconstitute the skim milk in purified form. The recombination process is performed under ambient temperature and pressure conditions.

In another aspect of the invention, juice or beverage concentrate (collectively identified herein below as “juice fluid), is the fluid being purified. As used herein, beverage concentrate shall mean a fluid derived from fruit and/or vegetable material reduced to a concentrated form by removing at least a portion of the water component of the fluid.

The juice fluid is transferred from the holding tank and passed through microfiltration. The microfiltration step removes bacteria and spores from the fluid. The step is performed under ambient temperature and pressure conditions.

To separate the solid and liquid phases of the juice fluid, the fluid is passed through nanofiltration. The nanofilters have pores ranging from about 0.1 to about 100 nanometers. The nanofiltration step is performed under ambient temperature and pressure conditions.

The water phase is passed through a reverse osmosis filter system as is well known in the art to remove any further organic or inorganic contaminants. The purified water phase may be retained for recombination, if desired.

The solid phase of the juice fluid derived from the nanofiltration step is absorbed with beads of cellulose and pectin coated with bovine Anti-IgG and Anti-IgA.The bead components bind with the solids to further remove any contaminants.

To separate the beads from the beads/solid phase mixture, the mixture is passed through microfiltration, which removes the coated beads. Pore sizes from about 0.01 microns to about 50 microns. The step is performed under ambient temperature and pressure conditions.

The separated beads can be collected and regenerated for reuse. The purified solid phase material from the juice fluid is recombined with the stored water phase to reconstitute the juice or beverage concentrate in a toxin-free and viral-free purified form. The recombination process is performed under ambient temperature and pressure conditions.

Having described the invention, it should be understood that the foregoing description of the invention is intended merely to be illustrative thereof and that other modifications, embodiments and equivalents may be apparent to those who are skilled in the art without departing from its spirit. Having thus described the invention, what we claim as new and desire to secure by United States letters patent is:

1. A method of purifying fluids comprising:
refrigerating a fluid comprising at least one solid component and at least one liquid component;
treating the fluid with a combination of carbon dioxide and nitrogen gas;
pasteurizing the fluid;
passing the fluid through at least one microfilter to remove bacteria and spores;
passing the fluid through at least one nanofilter to separate the at least one solid component from the at least one liquid component;
passing the at least one liquid component through a reverse osmosis system;
absorbing the at least one solid component with cellulose beads to form a bead/component mixture;
passing the mixture through at least one microfilter to separate the bead from the at least one solid component; and,
recombining the at least one solid component and the at least one liquid component to re-form the fluid.

2. The method of claim 1 wherein the fluid is selected from the group consisting of fluid dairy, fruit juice, vegetable juice, beverage concentrate and mixtures thereof.

3. The method of claim 1 wherein the fluid is treated with the combination carbon dioxide nitrogen gas from about 2 minutes to about 15 minutes.

4. The method of claim 1 further comprising providing the carbon dioxide nitrogen gas combination in an amount from about 0.5 volumes to about 6 volumes.

5. The method of claim 4 further comprising providing the carbon dioxide nitrogen gas combination wherein the ratio of carbon dioxide gas to nitrogen gas is about 95% CO₂+5% N2.

6. The method of claim 1 wherein the fluid is fluid dairy milk comprising skim milk and cream wherein the skim milk comprises at least one solid component and at least one liquid component.

7. The method of claim 6 further comprising providing a cream separator and passing the fluid dairy through the separator to separate the cream from the skim milk.

8. The method of claim 7 further comprising pasteurizing the cream with UHT and separately pasteurizing the skim milk with UHT.

9. The method of claim 8 wherein the skim milk is passed through the at least one microfilter wherein the microfilter has pores from about 0.01 microns to about 50.0 microns in diameter.

10. The method of claim 9 further comprising passing the skim milk through the at least one nanofilter wherein the nanofilter has pores from about 0.1 to about 100 nanometers in diameter to separate the at least one solid component from the at least one liquid component.

11. The method of claim 10 further comprising providing beads of cellulose and pectin coated with bovine Anti-IgG and Anti-IgA.

12. The method of claim 1 wherein the fluid is selected from the group consisting of fruit juice, vegetable juice, beverage concentrates and mixtures thereof.

13. The method of claim 12 further comprising pasteurizing the fluid with UHT.

14. The method of claim 13 wherein the fluid is passed through the at least one microfilter wherein the microfilter has pores from about 0.01 microns to about 50.0 microns in diameter.

15. The method of claim 14 further comprising passing the fluid through the at least one nanofilter wherein the nanofilter has pores from about 0.1 to about 100 nanometers in diameter to separate the at least one solid component from the at least one liquid component.

16. The method of claim 15 further comprising providing beads of cellulose and pectin coated with bovine Anti-IgG and Anti-IgA.
